(19) United States
(12) Patent Application Publication
(10) Pub. No.: US 2023/0208874 A1
(43) Pub. Date: Jun. 29, 2023

(54) SYSTEMS AND METHODS FOR SUPPRESSING DENIAL OF SERVICE ATTACKS

(71) Applicant: CenturyLink Intellectual Property LLC, Broomfield, CO (US)

(72) Inventors: Dean Ballew, Sterling, VA (US); John R.B. Woodworth, Amissville, VA (US)

(73) Assignee: CenturyLink Intellectual Property LLC, Broomfield, CO (US)

(21) Appl. No.: 17/936,024

(22) Filed: Sep. 28, 2022

Related U.S. Application Data
(60) Provisional application No. 63/294,370, filed on Dec. 28, 2021.

(51) Int. Cl. H04L 9/40

(52) U.S. Cl. CPC H04L 63/1458; H04L 63/1416

(57) ABSTRACT

A method for suppressing network traffic includes: detecting an overload condition at a target device in a network; determining a source address of high traffic associated with the overload condition at the target device; generating a traffic suppression request including a source-destination tuple including a source identifier corresponding to the source address and a destination identifier corresponding to an address of the target device; sending the traffic suppression request to a router; configuring the router with a filter based on the source-destination tuple of the traffic suppression request; and filtering traffic between the source address and the target device based on the configured filter.

### CROSS-REFERENCE TO RELATED APPLICATIONS

This application claims the benefit of U.S. Provisional Application No. 63/294,370 filed Dec. 28, 2021, entitled “Storm Suppressor,” which is incorporated herein by reference in its entirety.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND

Distributed Denial of Service (DDoS) attacks can be very disruptive and impact much more than the target. In fact, routers along the entire path (from source to victim) can suffer as they carry unwanted traffic associated with the attack. It is the primary function of the routers to move packets and not to perform costly analytics on the packets. Additionally, each router along the path may have a limited view of the full data transmitted to the target system. As such, the target device (or a dedicated monitoring device) may be one of very few points at which potential DDoS situations can be detected. However, in many cases the target device (or victim device) may overwhelmed to the point of service failure during a large-scale DDoS attack, thereby making it difficult for the target device to respond to the attack.

### SUMMARY

Aspects of embodiments of the present disclosure relate to systems and methods for detecting a Denial of Service attack and generating “requests” for help from routers under the system, where the requests include one or more source-destination tuples identifying the source and destination of the high traffic. In some embodiments, some aspects of embodiments of the present disclosure are implemented within potential target devices (e.g., computer systems), such as being implemented in hardware and/or software running on a processor and memory of a computer system or in an enhanced network interface (a “Smart” network interface card or NIC) or may be implemented by an network monitoring service that monitors network traffic to detect an attack, identify source-destination tuples, and generate a request for help that includes the identified source-destination tuples.

Once a request for help has been initiated, the request is propagated to the ingress point of the traffic (e.g., a router at the ingress point), as determined based on the source IP address. In some embodiments, a filter is applied to traffic matching the source-destination tuple, thereby causing the router to drop all matching packets. In some embodiments, the filter is an ephemeral (or self-decaying) filter that drops traffic for a configurable period of time (e.g., 100 seconds). After this period of time expires, the filter is automatically removed, thereby allowing traffic to continue and normalizing traffic for that tuple.

According to one embodiment of the present disclosure, a method for suppressing network traffic includes: detecting an overload condition at a target device in a network; determining a source address of high traffic associated with the overload condition at the target device; generating a traffic suppression request including a source-destination tuple including a source identifier corresponding to the source address and a destination identifier corresponding to an address of the target device; sending the traffic suppression request to a router; configuring the router with a filter based on the source-destination tuple of the traffic suppression request; and filtering traffic between the source address and the target device based on the configured filter.

The target device may be configured to generate the traffic suppression request.

A processor of a smart network interface card of the target device may be configured to generate the traffic suppression request.

A network monitoring device of the network may be configured to monitor computing resource usage at the target device and may be configured to detect the overload condition at the target device and to generate the traffic suppression request based on detecting the overload condition.

A software agent running on a device in the network may be configured to generate the traffic suppression request, and the software agent may be configured to receive network traffic information regarding network traffic flow within the network.

The software agent may select the router based on a path of the high traffic through the network.

The software agent may select the router at an ingress point of the high traffic into the network.

The software agent may select the router at an ingress point from the source address into a peering network connected to the network.

The software agent may select all routers in the network on a path taken by the high traffic from the source address to the target device.

The software agent may run on a software defined networking router of the network.

The software agent may run in a hypervisor, a container manager, or a host operating system of a computing device hosting the target device.

The software agent may participate in a route reflector network of the network and wherein the network traffic information includes route information from the route reflector network.

The router may be a gateway connected to the target device.

The traffic suppression request may be broadcast to all routers in the network.

The traffic suppression request may further include an expiration time.

The router may be configured to automatically remove the filter when the expiration time has elapsed.

The router may be configured to authenticate the traffic suppression request and to configure the router with the filter only if the traffic suppression request is authenticated.

The filtering traffic between the source address and the target device based on the configured filter may include: determining a match between a data packet of network traffic and the filter; and dropping the data packet in response to determining the match.

The filtering traffic between the source address and the target device based on the configured filter may further include: dropping a specified portion of data packets matching the filter.

The filtering may be performed on a best-effort basis in accordance with conditions in which the router has computing resources available to apply the filter without impacting the routing of network data packets through the router.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic diagram depicting a network in which high network traffic flows from a source device to a target device through a network path that includes a network router.

FIG. 2 is a flowchart of a method for generating a traffic suppression request in response to detecting high traffic according to one embodiment of the present disclosure.

FIG. 3 is a flowchart of a method for directing a request to a router in accordance with one embodiment of the present disclosure.

FIG. 4 is a flowchart of a method for suppressing traffic based on a filter configured by a traffic suppression request according to one embodiment of the present disclosure.

FIG. 5 is a block diagram of a computing device according to one embodiment of the present disclosure.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

Aspects of embodiments of the present disclosure relate to systems and methods for suppressing high traffic flowing between sources and targets or sinks within a network. In some embodiments, a target device (the recipient of the high traffic) or a network monitoring device detects network traffic conditions that indicate that network traffic suppression is appropriate. Upon detecting those conditions, the target device or the network monitoring device generates a traffic suppression request that is transmitted to one or more routers connected between the source and the target. The one or more routers then filter traffic in accordance with the traffic suppression request, such as by dropping (not forwarding) packets that match source and target IP addresses identified in the traffic suppression request. As a result, the network traffic from the source to the target is reduced, thereby suppressing the network traffic. In some embodiments, the filter is ephemeral, in that it is automatically removed after the expiration of a timer.

High network traffic can arise from various circumstances including: Distributed Denial of Service (DDoS) attacks; unexpectedly popular resources (e.g., viral social media); errors or misconfigurations in software applications (e.g., targeting specific network locations instead of a load balancer); persistent failures in systems (e.g., failures in data centers that result in all traffic being directed to a small number of targets); and the like. Whatever the source of the high traffic, in many cases, the target devices that receive the high traffic may lack the computing resources to respond to all of the received traffic.

For example, the high traffic may consume a large portion of CPU time, memory, network bandwidth, and/or persistent storage available on the target device (or may reach quotas associated with the container or virtual machine associated with the target device in the case of a containerized or virtualized target device). The associated high load on the target device may, in turn, cause the target device to become unresponsive (e.g., due to thrashing) or may otherwise overwhelm the system such that the target device is not able to provide its intended service to users (e.g., respond to legitimate requests in the case of a DDoS attack). For example, if the target device is a database and the database is flooded with incoming traffic that may perform expensive database operations (e.g., large JOIN operations across multiple tables and/or across large datasets), this traffic may degrade or shut down service to legitimate users of the database system, thereby disrupting other services (e.g., web sites) that depend on access to the database system. As another example, a web application exposing a Representational State Transfer (REST) application programming interface (API) over hypertext transfer protocol (HTTP) may be sent a large number of requests to retrieve, receive, edit, and/or replace data, which may place a higher load than the target device running the web application can handle, thereby causing failure or reduced access to the service. This failure or reduced access to the service may have upstream effects on other systems that depend on the service. For example, payment processing systems that depend on an overloaded service may fail, thereby causing economic harm to institutions relying on those services.

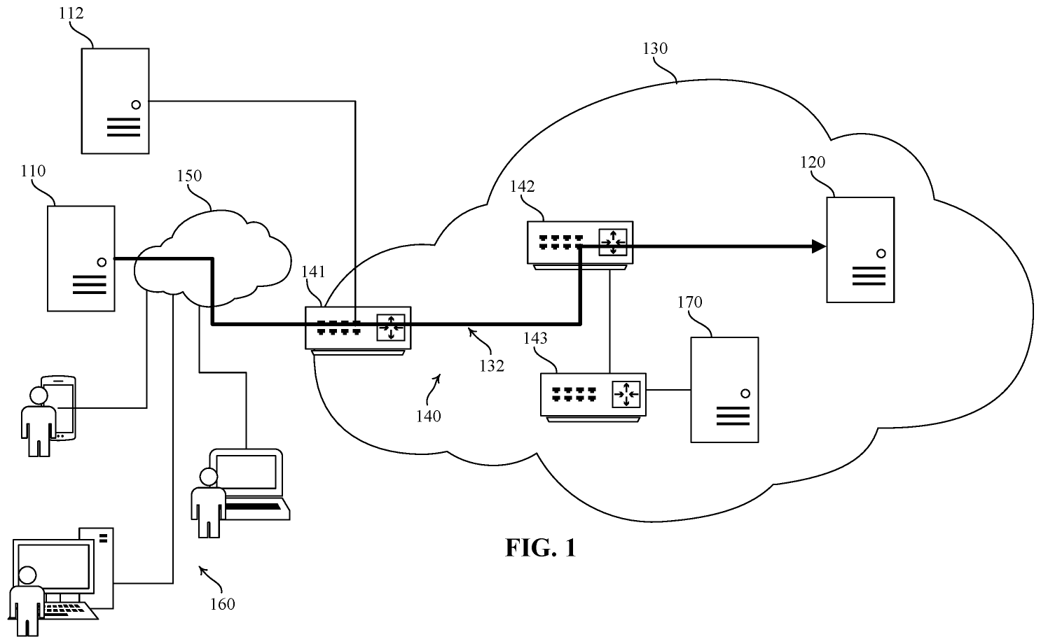

FIG. 1 is a schematic diagram depicting a network in which high network traffic flows from a source device to a target device through a network path that includes a network router. In the example shown in FIG. 1, high traffic flows from a source device 110 to a target device 120 located within a network 130. The high traffic flows along a network path 132 through one or more routers 140 of the network 130 on the way to the target device 120. In some embodiments, the network 130 includes one or more software defined networking (SDN) routers, and one or more of the routers 140 (e.g., first router 141, second router 142, and third router 143) shown in FIG. 1 may be SDN routers, where an SDN router includes a processor and memory. The source device 110 may be connected directly to the network 130 or may be connected to the network through one or more other networks 150 (e.g., one or more peering networks among different backbone telecommunications network providers, internet service providers, or the like).

The source device 110 may include one or more networked computing devices, such as servers, desktop computers, laptop computers, tablets, smartphones, and the like, which may send and receive network traffic over a computer network such as the Internet (e.g., the one or more networks 150). The target device 120 is, similarly, a networked computing device that is reachable via the network 130.

Generally, in the case of high traffic conditions such as a DDoS attack, the target device 120 includes a server (or a plurality of servers behind a load balancer), where the target device provides a network-accessible service that performs computing operations in response to requests. Examples of such network-accessible services include web servers, web applications, data storage services (e.g., databases, network attached storage, logging services, and blob storage), communications services (e.g., telephony, chat, and presence services), and the like. In some circumstances, the target device 120 is a virtualized computer running in a virtualization environment (e.g., a VMWare® virtual machine) and/or a containerized service running in a container environment (e.g., a Docker® container).

The high traffic from the source device 110 and/or multiple source devices to the target device 120, may increase the response latency of the target device 120 and/or may cause the target device to fail, thereby degrade the quality of the service delivered by the target device 120 to other users 160 connected to the target device 120 over the network 130.

As discussed above, some aspects of embodiments of the present disclosure relate to systems and methods for detecting high traffic and generating requests for help or requests to suppress the high traffic.

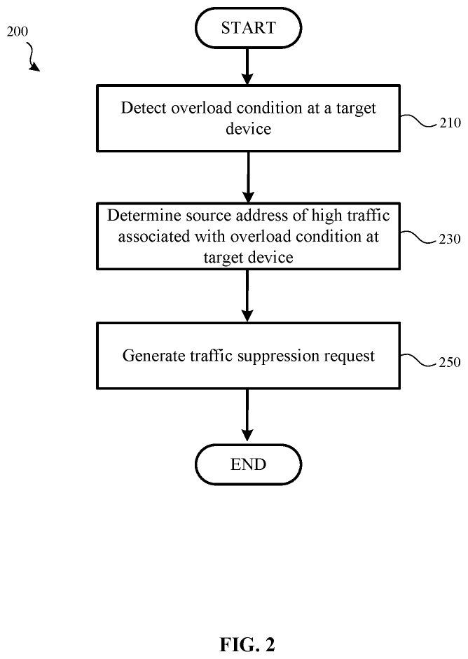

FIG. 2 is a flowchart of a method 200 for generating a traffic suppression request in response to detecting high traffic according to one embodiment of the present disclosure. In some embodiments, the method of FIG. 2 is performed by an overload detector.

In various different embodiments of the present disclosure, the method described with respect to FIG. 2 may be performed (and/or the overload detector may be implemented) by one or more systems or devices associated with the target device 120.

In some embodiments, the method shown in FIG. 2 is performed by the target machine that is receiving the high network traffic from the source device 110. In more detail, in some embodiments the method is performed by software stored in memory and executed by the processor of the machine, such within a networking stack or other networking subsystem within an operating system (e.g., kernel space) or within a user space application (e.g., as a part of a web application framework processing incoming requests). Accordingly, in some examples, the overload detector is be implemented in software.

As noted above, in some embodiments, the target device 120 is a virtual machine or a containerized machine running within a virtualization environment and may be managed by software such as a hypervisor running in a host environment on the physical computing hardware or a container manager. In some such embodiments, the method shown in FIG. 2 may be performed by (and/or the overload detector may be implemented within) the hypervisor, container manager, a host operating system, or software defined networking layer managing the routing of packets received at a hardware network interface to the virtualized or containerized target device 120.

In some embodiments, the target device 120 includes a smart network interface card (NIC) or is a virtualized or containerized device running on hardware that includes a smart NIC. In some such embodiments, the operations of FIG. 2 may be performed by the smart NIC. By offloading the performing of the algorithm away from the main processor(s) of the target device 120, these embodiments of the present disclosure enable traffic suppression requests to be generated even in circumstances where the main processor(s) is/are overloaded. (For example, in some configurations, the software service executed by the target device 120 is not associated with resource quotas or resource caps, and therefore it is possible for the high traffic to saturate the computing resources such that a process for generating traffic suppression requests is unable to run on the main processor(s) of the target device 120.) A smart NIC may comprise a network interface controller, associated memory for storing firmware and/or application(s), and one or more processor (or processing circuit) such as a central processing unit, a field programmable gate array, etc. Accordingly, in some examples, the overload detector is implemented within firmware of a smart NIC so that it can function even when the main processor(s) of the target device is/are overloaded.

In some embodiments, a network monitoring device 170 is configured to monitor network traffic within the network 130. In some examples, the network monitoring device 170 also monitors computing resource usage (e.g., CPU usage percentage, CPU load, memory usage, bandwidth usage, and the like) of various computing resources (e.g., monitoring resource usage of computing instances in a cloud computing environment) within the network 130, such as the target device 120. In some examples, the network monitoring device detects overload conditions based on reports from a network firewall (e.g., high traffic matching particular patterns). In some such embodiments, the network monitoring device 170 is configured to perform the operations of FIG. 2. Accordingly, in some examples, the overload detector is implemented in software or firmware of a monitoring device configured to monitor network activity on a network 130.

In some embodiments of the present disclosure, the operations of FIG. 2 are performed by a combination of above, such as redundantly by multiple systems and such as arrangements where different devices perform different operations.

Referring to FIG. 2, in operation 210, the overload detector detects an overload condition at a target device 120. In some embodiments, an overload condition is detected when a CPU usage percentage level exceeds a threshold (e.g., over 90% CPU usage for 10 minutes), when CPU load exceeds a value (e.g., over 10 waiting processes for 5 minutes), when network traffic exceeds a threshold, when the target device 120 fails to respond to a health check or heartbeat signal (or the latency of the response exceeds a threshold), or the like.

Accordingly, aspects of embodiments of the present disclosure are not limited to detecting and responding to intentional DDoS attacks, but instead may also apply to other circumstances in which incoming traffic causes an overload condition for other reasons (e.g., misconfiguration of devices, unexpected increases in popularity of services or particular media content, or the like).

In operation 230, the overload detector determines a source address of the traffic associated with overload at the target device 120. In some examples, the overload detector determines the source address by reading the source IP address from the packets associated with the detected high traffic. In some embodiments, the overload detector samples the network traffic directed toward the target device and identifies one or more source IP addresses that make up the largest portion of the traffic, such as by identifying outlier sources of traffic (e.g., 90% of traffic from a single IP address or from IP addresses within a particular range) or outlier sources that appear anomalous compared to typical traffic to the target device 120 (e.g., moderate traffic from an unusually high number of IP addresses in a shared IP range). In some examples, the traffic may be segregated based on type, such as a case where a particular service running on a particular port of the target device 120 is overloaded (but other services may not be overloaded), in which case the overload detector may restrict the identification of source addresses to data directed at the particular port associated with the overloaded service.

In operation 250, the overload detector generates a traffic suppression request based on the source identifier of the traffic and the target identifier (or destination identifier) of the target device 120.

According to some embodiments of the present disclosure a traffic suppression requests includes a source identifier and a target identifier (or destination identifier). In some examples, the source identifier is an internet protocol (IP) address associated with the source of the detected high traffic (e.g., the source device) and the target identifier or destination identifier is an IP address associated with the target device. In some examples, the source identifier identifies multiple IP addresses, such as by specifying an IP address range (e.g., a starting IP address and an ending IP address of a range), a subnetwork or subnet (e.g., specified by a subnet mask), or a list or other collection of multiple IP addresses. In some embodiments, the destination identifier is the IP address of the target device 120 (e.g., an IP address associated with the hardware or an IP address associated with a virtual machine). In some circumstances, the target device 120 may be behind a proxy or gateway or router that performs network address translation (NAT), in which case the destination identifier may be an IP address associated with the router that is configured to receive packets and perform network address translation to route packets to the target device 120. The combination of a source identifier and a destination identifier may be referred to herein as a source-destination tuple.

In some embodiments, the traffic suppression request also includes a lifetime or lifespan or time to live (TTL) value or expiration time (e.g., a representation of a particular point in time, such as a date and time or a number of second since midnight on Jan. 1, 1970 or Epoch time). In some embodiments, the traffic suppression request includes an expiration condition, e.g., specifying conditions under which the traffic suppression should stop, such as a drop in traffic to a specified level (e.g., a percentage of peak or a particular average number of packets per minute matching the source-destination tuple).

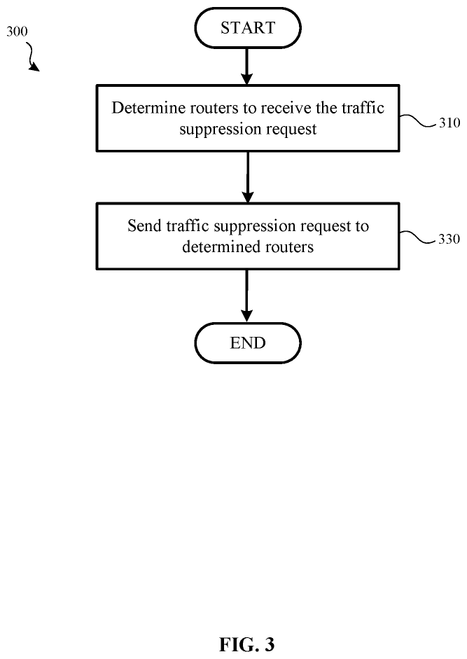

FIG. 3 is a flowchart of a method 300 for directing a request to a router in accordance with one embodiment of the present disclosure. Once a traffic suppression request been initiated, the traffic suppression request may be propagated to one or more router(s) along the path 132 between the source device 110 and the target device 120, as determined based on the source identifier in the source-destination tuple in the traffic suppression request.

In operation 310, a traffic suppression request routing system determines which one or more routers should receive the traffic suppression request, and in operation 330 traffic suppression request routing system transmits the traffic suppression request to the determined one or more routers identified in operation 310. In various example embodiments, the traffic suppression request routing system is implemented by the same device as the overload detector (such as a smart NIC of the target device 120) or implemented by a different device from the overload detector. For example, the traffic suppression request routing system may be implemented within the same software/firmware and hardware environment as the overload detector or in a different software/firmware and/or hardware environment (e.g., on the target device 120, in a hypervisor or container manager, in a software defined networking layer, in a smart NIC, in a network monitoring device, or the like). In some embodiments, the traffic suppression request routing system is implemented in one or more router(s) 140 directly upstream from the target device 120 (e.g., a network gateway).

In some embodiments, the traffic suppression request routing system is implemented by a software agent running within the network 130. For example, the software agent may run on a same device as the network monitoring device and/or may operate on other computing devices and/or may be distributed across multiple computing devices of network 130. In some embodiments, the software agent is executed within a software defined router among the routers 140, for example, as a process, a thread, or a plugin running on a processor of the software defined routers 140.

In some examples, the traffic suppression request routing system receives network traffic information from the routers 140 within the network 130. In some examples, the network traffic information received using the NetFlow protocol (developed by Cisco®, see, e.g., Internet Engineering Task Force (IETF) RFC3954) or the IP Flow Information Export (IPFIX) protocol, collected by NetFlow probes, packet capture appliances, and/or NetFlow collection servers within the network 130. In some embodiments, route information regarding the path 132 taken by the heavy network traffic affecting the target device 120 is retrieved from one or more route reflectors in the network 130. In some embodiments, the traffic suppression request routing system takes part in the route reflector network to receive information regarding the routes through the network 130. For example, the router 142 may act as a route reflector in the network 130 and may reflect all routes advertised by the other routers 141 and 143 to the other routers. As such, a traffic suppression request routing system (e.g., operating on one of the routers 140), may have access to all routes between the source-destination tuple. Accordingly, the traffic suppression request routing system may have more context regarding the state of the network and the path 132 taken by the heavy traffic from the source device 110 to the target device 120 and therefore may have additional information for selecting the routers 140 that would be effective in handling the traffic suppression request, such as by configuring network traffic filters, as described in more detail below.

In the example shown in FIG. 1, a first router 141 and a second router 142 are both located along the path 132 from the source device 110 to the target device 120, while a third router 143 is not included in the path 132. In some embodiments, the traffic suppression request is sent to all routers 140 within the network 130 (e.g., first router 141, second router 142, and third router 143).

In some examples, the traffic suppression request routing system determines which routers are on the path 132 between the source device 110 and the target device, based on the source identifier and the destination identifier in the source-destination tuple of the traffic suppression request and based on, for example, the configuration of the network 130 (e.g., configured routing tables), such that the traffic suppression request is transmitted only to the routers that are on the path (e.g., referring to FIG. 1, first router 141 and second router 142 may both receive the traffic suppression request because both are on the path 132, while third router 143 would not receive the request).

In some embodiments, the traffic suppression request routing system determines which router is the ingress point of the traffic (e.g., a router at the ingress point), as determined based on the source IP address, and sends the traffic suppression request only to the router at the ingress point to the network. In the particular example of FIG. 1, the first router 141 is depicted as being located at the edge of the network 130 and is the ingress point into the network 130 (in which the target device 120 is located) for the traffic along network path 132 from the other networks 150 (e.g., a source network in which the source device 110 is located or one or more peering networks between the source network and the network 130) or directly from a second source device 112, as shown in FIG. 1 (e.g., in a case where the second source device 112 is a source of high traffic to the target device 120).

In some embodiments, the traffic suppression request routing system determines a router located in a different network (e.g., one of the other networks 150) on the path 132 between the source device 110 and the target device 120 to receive the traffic suppression request. This may occur in circumstances where there are agreements or other protocols between different networks such that routers in one network will accept traffic suppression requests from a different network. For example, referring to FIG. 1, a router located at the edge of network 150, such as at an ingress point of the network traffic from the source device 110 into the network 150, or one or more routers within the other network or other networks 150 is determined as a router that is to be sent the traffic suppression request.

As noted above, in operation 330 the traffic suppression request routing system sends one or more traffic suppression requests to one or more routers (or other network devices) along a path 132 between the source device 110 and the target device 120.

In some examples, a router or other network device configured to receive and process a traffic suppression request uses information contained in the traffic suppression request to suppress traffic matching the information contained therein.

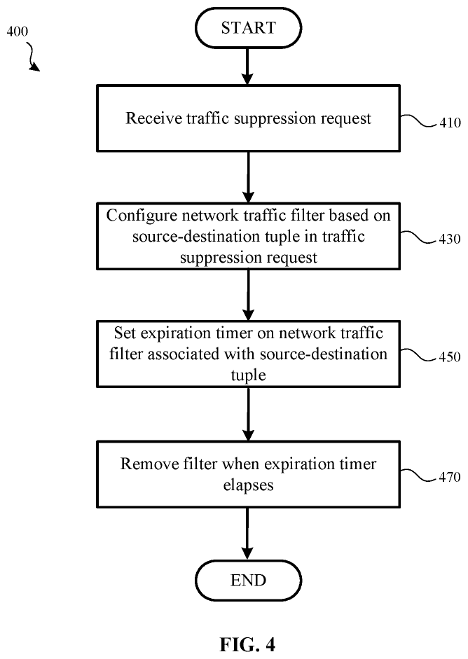

FIG. 4 is a flowchart of a method 400 for suppressing traffic based on a filter configured by a traffic suppression request according to one embodiment of the present disclosure. In operation 410, the router receives a traffic suppression request. In some examples, the router determines whether the traffic suppression request is to be handled by the router, such as by determining whether the router is an intended recipient of the request (e.g., the traffic suppression request may include a list of routers that were previously determined by the traffic suppression request routing system as the routers that are to receive the request). In some examples, the router may also authenticate the sender of the traffic suppression request (e.g., verifying a cryptographic signature) and/or may determine whether the sender of the request has permission to control the operation of the router (e.g., by checking against an access control list or other permissions settings), or the like. For example, in some embodiments, a router authenticates a traffic suppression request by communicating with a Remote Authentication Dial-In User Service (RADIUS) service running on a server internal to the network 130. In such embodiments, the router configures the filter only if the traffic suppression request is authenticated and ignores or rejects traffic suppression requests that are not authenticated.

In operation 430, the router configures a filter or network traffic filter based on the source-destination tuple from the traffic suppression request. In more detail, in some examples the router or other network device applies a filter to traffic (e.g., network data packets such as transmission control protocol (TCP) or user datagram protocol (UDP) packets) matching the source-destination tuple (e.g., the source identifier and the destination identifier) in the traffic suppression request, thereby causing the router to drop all matching network data packets or a specified portion (e.g., dropping a percentage or dropping any given matching packet with a specified probability) of matching network data packets. Continuing the examples presented above, the router may attempt to match a source IP address and a destination IP address of the packet (e.g., in a network layer header or IP header) with a source-destination tuple registered in a filter. In cases where the source identifier and the destination identifier (or target identifier) are each IP addresses, a packet matches when the source IP address in the packet and the destination IP address in the packet are both the same as the source IP address and destination IP address identified in the filter. Likewise, in circumstances where the filter specifies a range of IP addresses, a subnet, or a list of IP addresses, a packet is determined to match the filter if its source IP address and destination IP address match corresponding ranges, subnets, or lists of IP addresses as specified in the filter. In some examples where a target device 120 is among a group of IP addresses associated with an anycast IP address, the filter may remove the target device 120 from the group of anycast IP targets while the filter is in effect. In some additional examples where the target device 120 is associated with an anycast IP address, the filter modifies weights associated with different target IP address, such that a smaller percentage of the traffic to the anycast IP address is routed to the overloaded target device 120. In some examples, the filter is implemented using packet filtering software in the router such as iptables or nftables.

In some examples, the routers perform filtering on a best-effort basis, where the router applies the filter only under circumstances where the router has computing resources available to apply the filters without impacting the routing of other network data packets through the router (e.g., when the router is not under heavy load). In some examples, the filters are associated with a priority (e.g., sorted based on priority) where the router applies higher priority filters before lower priority filters. In some such examples, the higher priority filters may be filters associated with traffic that was determined by the overload detector, the traffic suppression request routing system, and/or the agent as traffic originating from a threat (e.g., a DDoS attack) and lower priority filters may be associated with legitimate high load traffic.

In some embodiments, the filter is an ephemeral (or self-decaying) filter that drops traffic for a configurable period of time (e.g., 100 seconds) based on an expiration timer. In these embodiments, in operation 450, the router sets an expiration timer on the network traffic filter that was configured based on the source-destination tuple in the traffic suppression request. In some embodiments, the expiration timer of the filter is set based on the value included in the traffic suppression request, e.g., a lifetime or lifespan or time to live (TTL) value or expiration time. After this period of time expires, the filter is automatically removed by the router, e.g., in operation 470, thereby allowing traffic to continue and normalizing traffic for that tuple.

The use of an ephemeral or self-decaying filter according to some embodiments of the present disclosure allow a “set and forget” approach to handling or mitigating heavy traffic loads. For example, in a case where the heavy traffic is due to a misconfiguration of one or more source devices, or a temporary or transient high load condition (e.g., the nearly simultaneous booting of multiple identical configurations, all seeking to connect to the same service at the same time), an ephemeral filter configured to temporarily suppress network traffic matching the source-destination tuples enables the overloaded target device 120 to recover from the heavy load and to receive and process some requests during each period when the filter is not active (e.g., requests from other sources or some queued requests from the source device 110). In contrast, in these circumstances, a permanent filter would completely deny access to the service to the source devices sending legitimate requests to the target device 120 until the filter was manually removed by a human engineer (which may involve a network engineer managing the source device to manually file a technical support ticket with the network engineering managing the network 130 associated with the target device 120).

An ephemeral network traffic filter according to embodiments of the present disclosure also serves to suppress traffic associated with DDoS attacks and also automatically restores normal traffic such that normal network operations can resume after the DDoS attack has ended, and also continuing to provide protection while the attack is ongoing, as further traffic suppression requests may be generated to establish filters on the routers to suppress network traffic associated with the attack while the attack is ongoing.

Some aspects of embodiments of the present disclosure relate to protocols for communicating traffic suppression requests between, for example, target devices (e.g., servers) and agents, between agents and routers, and between target devices and routers. For example, as noted above, in some embodiments, a traffic suppression request includes a source identifier and a destination identifier (a source-destination tuple) specifying the source IP address or IP addresses and the destination IP addresses corresponding to the traffic that is to be suppressed or filtered out. In some embodiments, the request also includes a time-to-live (TTL) value or other value specifying an expiration time or other expiration condition associated with the traffic.

Accordingly, aspects of embodiments of the present disclosure relate to systems and methods for automatically suppressing high traffic under conditions such as heavy loads or a denial of service attacks (e.g., distributed denial of service (DDoS) attacks). In more detail, one or more devices within the network detect an overload condition at one or more servers (or target devices) that receive heavy traffic from one or more source devices. Based on detecting the overload condition, one or more traffic suppression requests are transmitted to one or more routers located along a path or network path between the one or more source devices (source) and the one or more target devices (destination) receiving the heavy traffic, where each traffic suppression request includes a source-destination tuple. The one or more routers configure one or more filters to suppress the network traffic based on matching the source-destination tuple (e.g., to block some or all network data packets from a source IP address to a destination IP address). In some embodiments, the filter is ephemeral, e.g., automatically expires and is removed after a specified period of time has elapsed or at a specific point in time, thereby automatically restoring normal network traffic operations.

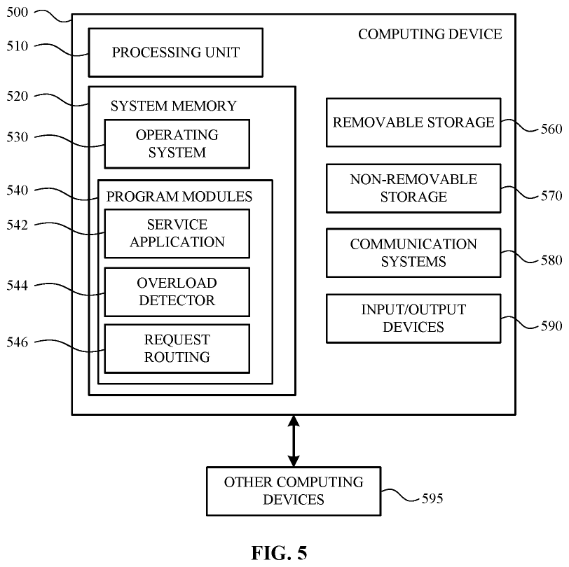

FIG. 5 is a system diagram of a computing device 500 according to an example. The computing device 500, or various components and systems of the computing device 500, may be integrated or associated with, for example, a computing device, a target device, a software defined network router, or a network monitoring device, shown and described herein. As shown in FIG. 5, the physical components (e.g., hardware) of the computing device are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540 that may execute the service application 542 providing a network accessible service in the case of a target device 120. The program modules 540 may be responsible for providing and/or generating a user interface to a computing device, generating detecting overload conditions 544, and/or traffic suppression requests and routing traffic suppression requests 546 as described above, where different devices, such as the target device 120, the routers 140, the network monitoring device 170, and the like, may have program modules 540 stored in the memory. A number of different program modules and data files may be stored in the system memory 520. While executing on the processing unit 510, the program modules 540 may perform the various processes described above.

The computing device 500 may also have additional features or functionality. For example, the computing device 500 may include additional data storage devices (e.g., removable and/or non-removable storage devices) such as, for example, solid state drives, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 such as, for example, routing engines, gateways, signings systems and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc. The communication systems 580 may be implemented by one or more network adapters, such as a smart network interface card (smart NIC).

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be tangible and non-transitory and does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Further, as used herein and in the claims, the phrase “at least one of element A, element B, or element C” is intended to convey any of: element A, element B, element C, elements A and B, elements A and C, elements B and C, and elements A, B, and C.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for suppressing network traffic, the method comprising:
detecting an overload condition at a target device in a network;
determining a source address of high traffic associated with the overload condition at the target device;
generating a traffic suppression request comprising a source-destination tuple comprising a source identifier corresponding to the source address and a destination identifier corresponding to an address of the target device;
sending the traffic suppression request to a router;
configuring the router with a filter based on the source-destination tuple of the traffic suppression request; and
filtering traffic between the source address and the target device based on the configured filter.

2. The method of claim 1, wherein the target device is configured to generate the traffic suppression request.

3. The method of claim 2, wherein a smart network interface card of the target device is configured to generate the traffic suppression request.

4. The method of claim 1, wherein a network monitoring device of the network is configured to monitor computing resource usage at the target device and is configured to detect the overload condition at the target device and to generate the traffic suppression request based on detecting the overload condition.

5. The method of claim 1, wherein a software agent running on a device in the network is configured to generate the traffic suppression request, and
wherein the software agent is configured to receive network traffic information regarding network traffic flow within the network.

6. The method of claim 5, wherein the software agent selects the router based on a path of the high traffic through the network.

7. The method of claim 6, wherein the software agent selects the router at an ingress point of the high traffic into the network.

8. The method of claim 6, wherein the software agent selects the router at an ingress point from the source address into a peering network connected to the network.

9. The method of claim 6, wherein the software agent selects all routers in the network on a path taken by the high traffic from the source address to the target device.

10. The method of claim 5, wherein the software agent runs on a software defined networking router of the network.

11. The method of claim 5, wherein the software agent runs in a hypervisor, a container manager, or a host operating system of the target device.

12. The method of claim 5, wherein the software agent participates in a route reflector network of the network and wherein the network traffic information includes route information from the route reflector network.

13. The method of claim 1, wherein the router is a gateway connected to the target device.

14. The method of claim 1, wherein the traffic suppression request is broadcast to all routers in the network.

15. The method of claim 1, wherein the traffic suppression request further comprises an expiration time, and wherein the router is configured to automatically remove the filter when the expiration time has elapsed.

16. A traffic suppression request routing system, comprising:
at least one processor; and
memory, operatively connected to the at least one processor and storing instructions that, when executed by the at least one processor, cause the system to perform a method, the method comprising:
receiving a traffic suppression request from a target device in a network;
determining, from the traffic suppression request, a source-destination tuple comprising a source identifier corresponding to a source address and a destination identifier corresponding to an address of the target device;
identifying one or more routers along one or more paths within the network via which traffic from the source address to the target device is carried; and
sending the traffic suppression request to the one or more routers.

17. The traffic suppression request routing system of claim 16, wherein identifying one or more routers along one or more paths within the network comprises identifying an ingress router of the network for the traffic, and wherein sending the traffic suppression request comprises sending the traffic suppression request to the ingress router.

18. The traffic suppression request routing system of claim 17, wherein the source identifier identifies a range of source addresses associated with a second network, and the ingress router is identified as a gateway into the network from the second network.

19. A target computing device, comprising:
at least one main processor;
memory, operatively connected to the at least one main processor and storing instructions that, when executed by the at least one main processor perform a service associated with at least one destination address; and
a smart network interface card (NIC), comprising:
a network interface controller;
at least one NIC processor; and
memory, operatively connected to the at least one NIC processor and storing instructions that, when executed by the at least one NIC processor, cause the smart NIC to perform a method, the method comprising:
detecting an overload condition at the at least one main processor;
determining a source address of traffic associated with the overload condition;
generating a traffic suppression request comprising a source-destination tuple comprising a source identifier corresponding to the source address and a destination identifier corresponding to an address of the target device; and
sending the traffic suppression request to a router.

20. The target computing device of claim 19, wherein the smart NIC is operable to perform the method while the at least one main processor is in the overload condition.
